(19) United States
(12) Patent Application Publication
(10) Pub. No.: US 2012/0194104 A1
(43) Pub. Date: Aug. 2, 2012

(54) HF RESONATOR CAVITY AND ACCELERATOR

(76) Inventor: Oliver Heid, Erlangen (DE)

(21) Appl. No.: 13/499,898

(22) PCT Filed: Aug. 25, 2010
(86) PCT No.: PCT/EP2010/062373

§ 371 Date: Apr. 2, 2012

(30) Foreign Application Priority Data
Oct. 6, 2009 (DE) 10 2009 048 400.0

(51) Int. Cl. H05H 7/02

(52) U.S. Cl. 315/501

(57) ABSTRACT

An RF resonator cavity for accelerating charged particles comprises an RF resonator cavity in which an electromagnetic RF field acts on a particle beam which passes through the RF resonator cavity along a beam path, and at least one intermediate electrode arranged in the RF resonator cavity along the beam path of the particle beam, the intermediate electrode increasing an electrical breakdown resistance in the resonator cavity. An accelerator for accelerating charged particles, which includes such RF resonator cavity, is also provided.

### CROSS-REFERENCE TO RELATED APPLICATIONS

This application is a U.S. National Stage Application of International Application No. PCT/EP2010/062373 filed Aug. 25, 2010, which designates the United States of America, and claims priority to DE Patent Application No. 10 2009 048 400.0 filed Oct. 6, 2009. The contents of which are hereby incorporated by reference in their entirety.

### TECHNICAL FIELD

The disclosure relates to an RF resonator cavity with which charged particles in the form of a particle beam can be accelerated when they are guided through the RF resonator cavity and when an RF field acts on the particle beam in the RF resonator cavity, and to an accelerator having an RF resonator cavity of this type.

### BACKGROUND

The acceleration produced with a conventional RF resonator cavity typically depends on the strength of the electromagnetic RF field produced in the RF resonator cavity, which RF field acts along the particle path on the particle beam. Because with increasing field strengths of the RF field the likelihood increases that sparkovers between the electrodes occur, the maximum achievable particle energy is limited by the RF resonator cavity.

The electrical sparkover problem in particle accelerators was investigated by W. D. Kilpatrik in the document “Criterion for Vacuum Sparking Designed to Include Both rf and dc”, Rev. Sci. Instrum. 28, 824-826 (1957). In a first approximation, the 18525560 maximum achievable field strength E of the electrical RF field relates to the frequency f of the RF field as follows: E ˜√f. This means that higher electrical field strengths can be achieved if a higher frequency is used before an electrical sparkover (also referred to as “breakdown” or “RF breakdown”) occurs.

### SUMMARY

In an embodiment, an RF resonator cavity for accelerating charged particles is provided, wherein an electromagnetic RF field can be coupled into the RF resonator cavity which acts during operation on a particle beam which passes through the RF resonator cavity, wherein at least one intermediate electrode for increasing the electrical breakdown resistance is arranged in the RF resonator cavity along the beam path of the particle beam.

In a further embodiment, the intermediate electrode is insulated from a wall of the RF resonator cavity such that the intermediate electrode during operation of the RF resonator cavity does not produce an RF field which acts on the particle beam in an accelerating manner. In a further embodiment, the intermediate electrode is coupled via a conducting connection to the wall of the RF resonator cavity such that the conducting connection has a high impedance at the operating frequency of the RF resonator cavity, as a result of which the intermediate electrode is insulated with respect to the wall of the RF resonator cavity such that the intermediate electrode during operation of the RF resonator cavity does not produce an RF field which acts on the particle beam in an accelerating manner. In a further embodiment, the conducting connection comprises a helically guided conductor portion. In a further embodiment, the intermediate electrode is moveably mounted. In a further embodiment, the intermediate electrode is moveably mounted by way of a resilient bearing. In a further embodiment, the resilient bearing is configured in the shape of a hairpin. In a further embodiment, the resilient bearing comprises a helical conducting portion. In a further embodiment, the material of the intermediate electrode comprises chromium, vanadium, titanium, molybdenum, tantalum and/or tungsten. In a further embodiment, the intermediate electrode has the shape of a ring disk. In a further embodiment, a plurality of intermediate electrodes are arranged one after the other in the beam direction. In a further embodiment, the plurality of intermediate electrodes are moveably mounted. In a further embodiment, the plurality of intermediate electrodes are connected to one another via resilient bearings. In a further embodiment, the resilient bearings with which the plurality of intermediate electrodes are connected to one another are configured in the shape of a hairpin. In a further embodiment, the resilient bearings with which the plurality of intermediate electrodes are connected to one another comprise a helical conducting portion.

In another embodiment, an accelerator for accelerating charged particles comprises an RF resonator cavity according to any of the embodiments discussed above.

### BRIEF DESCRIPTION OF THE DRAWINGS

Example embodiments will be explained in more detail below with reference to figures, in which:

FIG. 1 shows schematically the construction of an example RF resonator cavity with inserted intermediate electrodes, according to an example embodiment, and

FIG. 2 shows a longitudinal section through such an RF resonator cavity, according to an example embodiment.

### DETAILED DESCRIPTION

Some embodiments provide an RF resonator cavity with high breakdown resistance.

In some embodiments, an RF resonator cavity for accelerating charged particles is provided, into which an electromagnetic RF field can be coupled which acts during operation on a particle beam which passes through the RF resonator cavity, wherein at least one intermediate electrode for increasing the electrical breakdown resistance is arranged in the RF resonator cavity along the beam path of the particle beam.

It has been found that an application of the criterion according to Kilpatrik has triggered a trend in accelerators toward high frequencies. However, this is a problem especially for the acceleration of slow particles, that is to say of particles with non-relativistic velocities, for ion-optical reasons. In large accelerators this means that in the first accelerator stages low frequency and a corresponding low E-field strength is used for operation and that typically only the later, subsequent accelerator stages are operated at the more advantageous higher frequency. Owing to the synchronicity the frequencies have a rational ratio with respect to one another. This, however, may lead to accelerators requiring a large amount of space and also to less flexibility in the choice of accelerator design.

However, particular aspects of the invention are based on the realization that it is not necessarily the frequency (according to the Kilpatrik criterion) that influences the maximum achievable E-field strength in a vacuum as an essential factor but also the electrode distance d, in a first approximation given by the relationship E ˜1/√d (for the dielectric strength U in a first approximation U ˜√d). In the book “Lehrbuch der Hochspannungstechnik,” G. Lesch, E. Baumann, Springer-Verlag, Berlin/Göttingen/Heidelberg, 1959, page 155 shows a diagram for illustrating the relationship between breakdown field strength in a high vacuum and plate distance. This relationship obviously applies universally over a very large voltage range, in the same manner for DC and AC voltage and for geometrically scaled electrode forms. The choice of electrode material obviously influences only the proportionality constant.

The experimental criterion of Kilpatrik E ˜√f contains no parameter which explicitly takes into account the electrode distance. This apparent contradiction to the relationship above which does include the electrode distance is resolved, however, if it is assumed that the form of the resonator during scaling for matching the frequency remains geometrically similar, so that the electrode distance is scaled together with the other dimensions of the resonator. This means a choice of the electrode distance d according to d ˜1/f and thus a correspondence between the Kilpatrik criterion E ˜√f with the above-established criterion E ˜1/√d.

As a consequence of this consideration it is found that high frequencies only appear to be helpful. The frequency dependence according to the Kilpatrik criterion can be simulated at least partially by the geometric scaling for resonance tuning.

However, it is possible for the frequency in the larger context independently of the desired maximum E-field strength of the RF field to be selected such that compact accelerators in principle become possible also at low frequencies, for example for heavy ions. This is achieved by way of the RF resonator cavity disclosed herein since here the breakdown resistance is countered with the intermediate electrodes. Eventually this achieves that a highly electrical breakdown resistance and associated high E-field strengths by observing the criterion E ˜1/√d. The operating frequency of the RF resonator can be selected in a clearly more flexible manner ideally independently of the desired E-field strength, the electrical breakdown resistance to be achieved is made possible by the intermediate electrodes and not the choice of the operating frequency.

Here an aspect of the invention involves the consideration of using smaller electrode distances in order to achieve higher E-field strengths. However, since the electrode distances are first given by the resonator form, a smaller electrode distance is here solved by introducing the intermediate electrode(s). The distance between the electrodes is consequently divided by the intermediate electrode(s) into smaller sections. The distance requirement with regard to breakdown resistance can thus be fulfilled largely independently of the resonator size and type.

The intermediate electrodes serve for increasing the electrical breakdown resistance. In order to influence the RF resonator cavity as little as possible in terms of its accelerating properties, the intermediate electrode can be insulated from the walls of the RF resonator cavity such that the intermediate electrode during operation of the RF resonator cavity does not produce an RF field which acts on the particle beam in an accelerating manner. Owing to the insulation, no RF power is transferred from the walls to the intermediate electrodes which would otherwise generate an RF field acting on the particle beam starting from the intermediate electrodes.

During operation, in this case no RF field is transferred from the resonator walls to the intermediate electrode, or to such a small extent that the RF field emitted by the intermediate electrode—if at all—is negligible and in the best case does not contribute to the acceleration of the particle beam at all or influence the acceleration. In particular, no RF currents flow from the resonator walls to the intermediate electrodes.

The insulation with respect to the resonator walls does not necessarily need to be complete, it suffices to configure the coupling of the intermediate electrode to the resonator walls such that the intermediate electrode in the frequency range of the operating frequency of the RF cavity is largely insulated. For example the intermediate electrode can be coupled via a conducting connection to a wall of the RF resonator cavity such that the conducting connection has a high impedance at the operating frequency of the RF resonator cavity, as a result of which the desired insulation with respect to the intermediate electrode can be achieved. The intermediate electrode is consequently largely decoupled in terms of RF energy from the RF resonator cavity. Thus the RF resonator cavity is damped by the intermediate electrodes only to a small extent. The conducting connection can nevertheless at the same time assume the function of charge dissipation by scattering particles. The high impedance of the conducting connection can be realized via a helically guided conductor portion.

The intermediate electrodes are arranged in particular vertically to the electric RF field acting on the particle beam. Thus as low an influence as possible on the functionality of the RF cavity by the intermediate electrodes is achieved.

The intermediate electrode can for example have the shape of a ring disk, having a central hole, through which the particle beam is guided. The form of the intermediate electrodes can be matched to the E-field potential surfaces which occur without intermediate electrodes such that no significant distortion of the ideal, intermediate-electrode-free E-field configuration occurs. With such a form, the capacitance increase owing to the additional structures is minimized, a detuning of the resonator and local E-field enhancement are largely avoided.

The intermediate electrode may be moveably mounted, for example by way of a resilient bearing or suspension. The resilient bearing can be configured in the shape of a hairpin. Thus the creeping discharge path along the surface is optimized or maximized, the likelihood of creeping discharges occurring is minimized. The resilient bearing can comprise a helical conducting portion, as a result of which an impedance increase of the resilient bearing at the operating frequency of the RF resonator cavity can be achieved.

The material of the intermediate electrode used can be, for example, chromium, vanadium, titanium, molybdenum, tantalum, tungsten or an alloy comprising these materials. These materials have a high E-field strength. The lower surface conductivity in these materials is tolerable because in the regions of high E-field strengths that are to be protected typically only low tangential H fields (and thus wall current densities) occur.

In some embodiments, a plurality of intermediate electrodes are arranged one after the other in the RF resonator cavity in the beam direction. The plurality of intermediate electrodes can be moveably mounted, for example with respect to one another via a resilient suspension. Thus the individual distances of the electrodes automatically uniformly distribute themselves.

The resilient bearings with which the plurality of intermediate electrodes are connected to one another can be configured to be conducting and preferably comprise a helical conducting portion and/or be configured in the shape of a hairpin. This also permits charge dissipation by scattering particles between the intermediate electrodes.

The accelerator may comprise at least one of the above-described RF resonator cavity with an intermediate electrode.

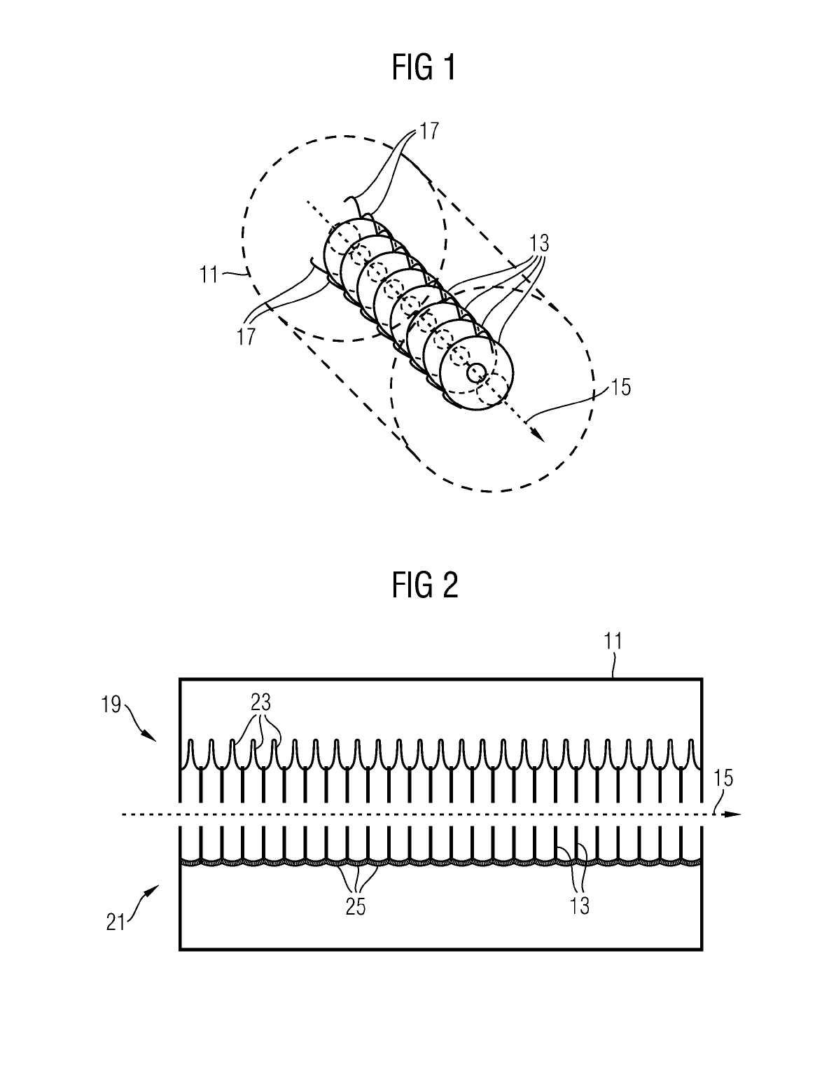

FIG. 1 shows an example RF resonator cavity 11, according to an example embodiment. The RF resonator cavity 11 itself is illustrated in dashed lines, in order to be able to more clearly illustrate the intermediate electrodes 13 which are located inside the RF resonator cavity 11.

The RF resonator cavity 11 typically comprises conducting walls and is supplied with RF energy by an RF transmitter (not illustrated here). The accelerating RF field acting on the particle beam 15 in the RF resonator cavity 11 is typically produced by an RF transmitter arranged outside the RF resonator cavity 11 and is introduced into the RF resonator cavity 11 in a resonant manner. The RF resonator cavity 11 typically contains a high vacuum.

The intermediate electrodes 13 are arranged along the beam path in the RF resonator cavity 11. The intermediate electrodes 13 are configured in the form of a ring with a central hole, through which the particle beam passes. A vacuum is situated between the intermediate electrodes 13.

The intermediate electrodes 13 are mounted with a resilient suspension 17 with respect to the RF resonator cavity 11 and with respect to one another.

Owing to the resilient suspension 17, the intermediate electrodes 13 distribute themselves automatically over the length of the RF resonator cavity 11. Additional suspensions, which serve for stabilizing the intermediate electrodes 13 (not illustrated here), can likewise be provided.

FIG. 2 shows a longitudinal section through the example RF resonator cavity 11 shown in FIG. 1, wherein here different types of suspension of the intermediate electrodes 13 with respect to one another and with respect to the resonator walls are shown.

The top half 19 of FIG. 2 shows a resilient suspension of the intermediate electrodes 13 with hairpin-shaped conducting connections 23. Owing to the hairpin shape, the likelihood of a creeping discharge along the suspension decreases.

In the bottom half of the RF resonator cavity 11 shown in FIG. 2, the intermediate electrodes 13 are connected via helically guided, conducting resilient connections 25 with respect to one another and with respect to the resonator walls. This configuration has the advantage that the helical guidance of the conducting connection 25 constitutes an impedance which produces in the case of a corresponding configuration the desired insulation of the intermediate electrodes with respect to the resonator walls at the operating frequency of the RF resonator cavity 11. In this manner, too much damping of the RF resonator cavity 11 owing to the insertion of the intermediate electrodes 13 into the RF resonator cavity 11 is avoided.

### List of Elements Shown in the Drawings

11 RF Resonator Cavity

13 Intermediate Electrode

15 Particle Beam

17 Suspension

19 Top Part

21 Bottom Part

23 Hairpin-shaped Connection

25 Helical Connection

What is claimed is:

1. An RF resonator cavity for accelerating charged particles, comprising:
an RF resonator cavity in which an electromagnetic RF field acts on a particle beam which passes through the RF resonator cavity along a beam path, and
an intermediate electrode arranged in the RF resonator cavity along the beam path of the particle beam, the intermediate electrode increasing an electrical breakdown resistance in the resonator cavity.

2. The RF resonator cavity of claim 1, wherein the intermediate electrode (13) is insulated from a wall of the RF resonator cavity such that the intermediate electrode does not produce an RF field that acts on the particle beam in an accelerating manner.

3. The RF resonator cavity of claim 1, wherein the intermediate electrode is coupled to a wall of the RF resonator cavity via a conducting connection such that the conducting connection has a high impedance at the operating frequency of the RF resonator cavity, as a result of which the intermediate electrode is insulated with respect to the wall of the RF resonator cavity such that the intermediate electrode does not produce an RF field which acts on the particle beam in an accelerating manner.

4. The RF resonator cavity of claim 3, wherein the conducting connection comprises a helically guided conductor portion.

5. The RF resonator cavity of claim 1, wherein the intermediate electrode is moveably mounted.

6. The RF resonator cavity of claim 5, wherein the intermediate electrode is moveably mounted by way of a resilient bearing.

7. The RF resonator cavity of claim 5, wherein the resilient bearing is configured in the shape of a hairpin.

8. The RF resonator cavity of claim 6, wherein the resilient bearing comprises a helical conducting portion.

9. The RF resonator cavity of claim 1, wherein the material of the intermediate electrode comprises at least one of chromium, vanadium, titanium, molybdenum, tantalum, and tungsten.

10. The RF resonator cavity of claim 1, wherein the intermediate electrode has a shape of a ring disk.

11. The RF resonator cavity of claim 1, comprising a plurality of intermediate electrodes arranged in series along the beam path.

12. The RF resonator cavity of claim 11, wherein the plurality of intermediate electrodes are moveably mounted.

13. The RF resonator cavity of claim 11, wherein the plurality of intermediate electrodes are connected to each another via resilient bearings.

14. The RF resonator cavity of claim 13, wherein the resilient bearings have a hairpin shape.

15. The RF resonator cavity of claim 14, wherein the resilient bearings with comprise a helical conducting portion.

16. An accelerator for accelerating charged particles, comprising:
an RF resonator cavity comprising:
an RF resonator cavity in which an electromagnetic RF field acts on a particle beam which passes through the RF resonator cavity along a beam path, and
at least one intermediate electrode arranged in the RF resonator cavity along the beam path of the particle beam, the at least one intermediate electrode increasing an electrical breakdown resistance in the resonator cavity.

17. The accelerator of claim 16, wherein the intermediate electrode is insulated from a wall of the RF resonator cavity such that the intermediate electrode does not produce an RF field that acts on the particle beam in an accelerating manner.

18. The accelerator of claim 16, wherein the intermediate electrode is coupled to a wall of the RF resonator cavity via a conducting connection such that the conducting connection has a high impedance at the operating frequency of the RF resonator cavity, as a result of which the intermediate electrode is insulated with respect to the wall of the RF resonator cavity such that the intermediate electrode does not produce an RF field which acts on the particle beam in an accelerating manner.
